(19) United States
(12) Patent Application Publication
(10) Pub. No.: US 2025/0216926 A1
(43) Pub. Date: Jul. 3, 2025

(54) SERVER DEVICE

(71) Applicant: Wiwynn Corporation, New Taipei City (TW)

(72) Inventors: Yu-Chun Chen, New Taipei City (TW); Chuan-Zhou Hung, New Taipei City (TW); Shi-Rui Chen, New Taipei City (TW); Jiuan-Da Lee, New Taipei City (TW); Wei-Fang Chang, New Taipei City (TW); Chung-Hui Yen, New Taipei City (TW)

(73) Assignee: Wiwynn Corporation, New Taipei City (TW)

(21) Appl. No.: 18/929,532

(22) Filed: Oct. 28, 2024

(30) Foreign Application Priority Data
Jan. 2, 2024 (TW) 113100071

(51) Int. Cl. G06F 1/3296; G06F 1/26; G06F 1/28

(52) U.S. Cl. CPC G06F 1/3296; G06F 1/266; G06F 1/28

(57) ABSTRACT

A server device includes a first circuit board, a second circuit board, and a plurality of third circuit boards. The first circuit board has a plurality of first connectors and a plurality of circuit components, and the circuit components are respectively coupled to the first connectors. The second circuit board has a controller and a plurality of resistor circuits, and a plurality of input terminals of the controller are respectively coupled to the resistor circuits. The third circuit boards respectively have a plurality of second connectors and a plurality of first resistors, the first resistors are respectively coupled to the second connectors, the second connectors are respectively detachably coupled to the first connectors, and the third circuit boards are respectively coupled to the input terminals of the controller. The controller determines an insertion status of each third circuit board by detecting voltages on the input terminals.

### CROSS-REFERENCE TO RELATED APPLICATION

This application claims the priority benefit of Taiwan application serial no. 113100071, filed on Jan. 2, 2024. The entirety of the above-mentioned patent application is hereby incorporated by reference herein and made a part of this specification.

### BACKGROUND

### Technical Field

This disclosure relates to a server device, and particularly relates to a multi-module docking server device.

### Description of Related Art

The current server device provides a multi-node system. The multi-node system may provide multiple detachable circuit boards to adaptively expand the function of the server device. In the conventional server device, in order to detect the connection status of the circuit board, a large number of signal lines are required to detect the signals between each circuit board, thereby determining whether the circuit board is inserted. In addition, if it is necessary to detect the insertion position of the circuit board simultaneously, more signal lines are required to interpret the circuit board, which leads to an expansion of the circuit area and increases the complexity of the server device, reducing the working performance of the server device.

### SUMMARY

A server device according to the disclosure includes a first circuit board, a second circuit board, and a plurality of third circuit boards. The first circuit board has a plurality of first connectors and a plurality of circuit components, and the circuit components are respectively coupled to the first connectors. The second circuit board has a controller and a plurality of resistor circuits, and a plurality of input terminals of the controller are respectively coupled to the resistor circuits. The third circuit boards respectively have a plurality of second connectors and a plurality of first resistors, the first resistors are respectively coupled to the second connectors, the second connectors are respectively detachably coupled to the first connectors, and the third circuit boards are respectively coupled to the input terminals of the controller. The controller determines an insertion status of each third circuit board by detecting voltages on the input terminals.

### BRIEF DESCRIPTION OF THE DRAWINGS

FIG. 1 illustrates a schematic circuit diagram of a server device according to an embodiment of the disclosure.

FIG. 2 illustrates a schematic circuit diagram of a server device according to another embodiment of the disclosure.

FIG. 3 illustrates a schematic circuit diagram of a server device according to another embodiment of the disclosure.

FIG. 4 illustrates an operational flow chart of a server device according to an embodiment of the disclosure.

### DESCRIPTION OF THE EMBODIMENTS

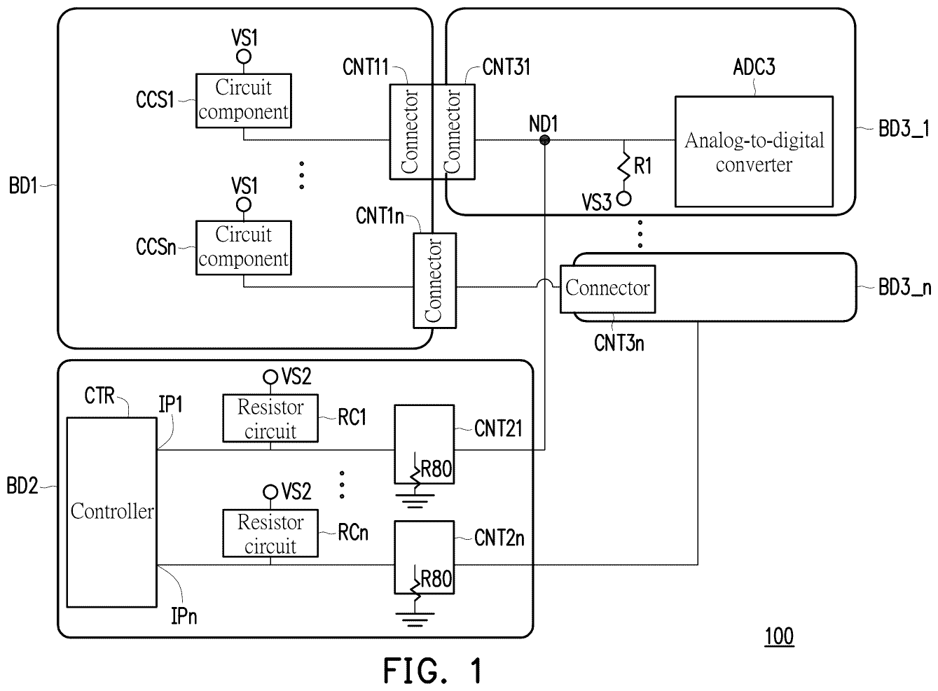

Please refer to FIG. 1. FIG. 1 illustrates a schematic circuit diagram of a server device according to an embodiment of the disclosure. A server device 100 includes a first circuit board BD1, a second circuit board BD2, and third circuit boards BD3_1 to BD3_n. A value n mentioned in the embodiment may be any positive integer.

In the embodiment, the first circuit board BD1 includes circuit components CCS1 to CCSn and connectors CNT11 to CNT1n. First terminals of the circuit components CCS1 to CCSn all receive a reference voltage VS1, and second terminals of the circuit components CCS1 to CCSn are coupled to the connectors CNT11 to CNT1n respectively.

In the embodiment, the second circuit board BD2 includes a controller CTR, the connectors CNT21 to CNT2n, and resistor circuits RC1 to RCn. The controller CTR may have input terminals IP1 to IPn. The input terminals IP1 to IPn may be coupled to the connectors CNT21 to CNT2n respectively, and the input terminals IP1 to IPn may be coupled to the corresponding resistor circuits RC1 to RCn respectively. The resistor circuits RC1 to RCn all receive a reference voltage VS2. The connectors CNT21 to CNT2n all have a resistor R80.

In the embodiment, the third circuit boards BD3_1 to BD3_n have the same circuit architecture, and further includes connectors CNT31 to CNT3n. Taking the third circuit board BD3_1 as an example, the third circuit board BD3_1 includes connector CNT31, a resistor R1, and an analog-to-digital converter ADC3. In each of the third circuit boards BD3_1 to BD3_n, a first terminal of the resistor R1 may receive a reference voltage VS3, and a second terminal of the resistor R1 may be coupled to the connector CNT31. In the third circuit board BD3_1, the resistor R1 and the connector CNT31 may be coupled to a node ND1. Each of the third circuit boards BD3_1 to BD3_n is coupled between the first circuit board BD1 and the second circuit board BD2 in a detachable coupling manner.

For example, the connector CNT31 of the third circuit board BD3_1 may be coupled to the connector CNT11 of the first circuit board BD1, and the third circuit board BD3_1 may be coupled to the connector CNT21 through a cable. In this way, the circuit component CCS1, the resistor circuit RC1, and the resistor R1 may form a divider loop between the reference voltages VS1 to VS3, and generate a divider voltage at the node ND1. Therefore, by enabling the circuit component CCS1 on the first circuit board BD1 to have a specific resistance value, based on the fact that the input terminal IP1 and the node ND1 of the controller CTR are substantially short-circuited to each other, the controller CTR may learn whether the third circuit board BD3_1 is inserted according to the voltage on the input terminal IP1 (which is equivalent to the divider voltage on the node ND1) and the connector (one of the connectors CNT11 to CNT1n) which the third circuit board BD3_1 is inserted into.

According to the above description, in the embodiment of the disclosure, by enabling the circuit components CCS1 to CCSn in the first circuit board BD1 to provide different resistance values respectively, the controller CTR may learn whether the third circuit boards BD3_1 to BD3_n are inserted into the corresponding connectors CNT11 to CNT1n respectively according to the voltage values on the input terminals IP1 to IPn corresponding to the third circuit boards BD3_1 to BD3_n respectively.

In addition, the controller CTR may simultaneously determine the insertion status of whether each of the third circuit boards BD3_1 to BD3_n is inserted by detecting the voltages of the input terminals IP1 to IPn. Furthermore, the controller CTR may determine the insertion position of each of the inserted third circuit boards BD3_1 to BD3_n by detecting the voltages of the input terminals IP1 to IPn.

In the embodiment, the controller CTR may determine whether multiple cables between the second circuit board BD2 and the third circuit boards BD3_1 to BD3_n are plugged in through the resistor circuits RC1 to RCn of the second circuit board BD2.

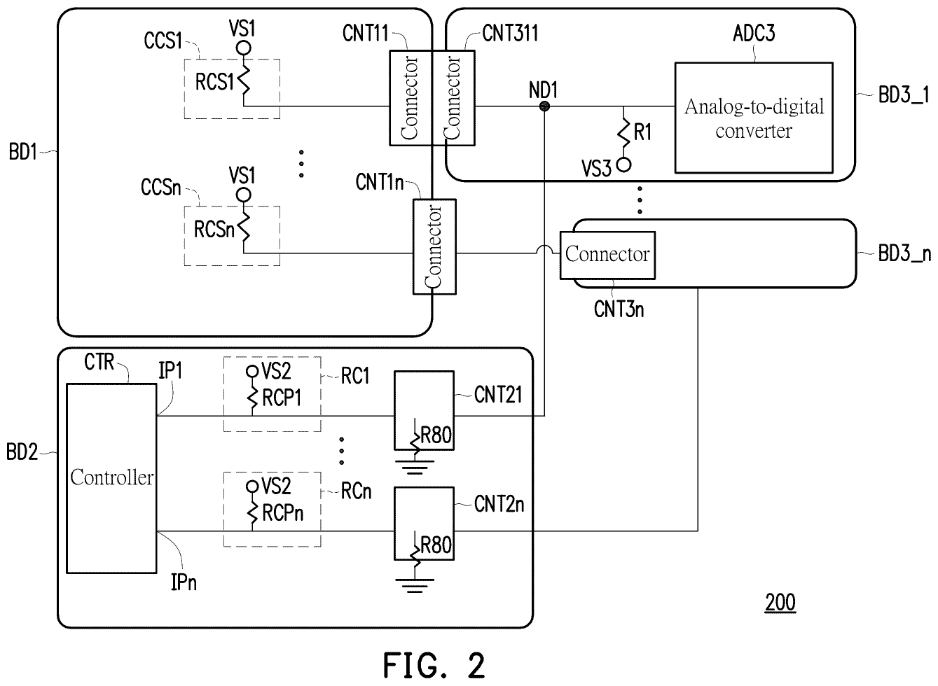

Please refer to FIG. 2. FIG. 2 illustrates a schematic circuit diagram of a server device according to an embodiment of the disclosure. In the embodiment, in a server device 200, the circuit components CCS1 to CCSn on the first circuit board BD1 may be resistors RCS1 to RCSn respectively. Moreover, the resistor circuits RC1 to RCn in the second circuit board BD2 may be resistors RCP1 to RCPn respectively.

In the embodiment, the resistance value of the resistor R1 may be 10K ohms, and the resistance value of the resistor RCP may be 120K ohms. Note that the above resistance values may be set according to actual requirement with no particular limitation.

First terminals of the resistors RCS1 to RCSn may all receive the reference voltage VS1, and each resistor RCP1˜RCPn may receive the reference voltage VS2. For example, the reference voltage VS1 and the reference voltage VS2 may be the same 2.5 volts (V). The reference voltages VS3 in the third circuit boards BD3_1 to BD3_n may all be the ground voltage (0V), which means that the resistors R1 in the third circuit boards BD3_1 to BD3_n may be coupled between the connectors CNT31 to CNT3n and the ground voltage respectively. In addition, the controller CTR in the embodiment may be an analog-to-digital converter. Note that in the embodiment, the resistance values of the resistors RCS1 to RCSn are all different, and when the third circuit boards BD3_1 to BD3_n are inserted into the corresponding connectors CNT11 to CNT1n respectively, the input terminals IP1 to IPn of the controller CTR have different voltage values.

In the embodiment, the controller CTR may individually determine the insertion statuses of the input terminals IP1 to IPn to the third circuit boards BD3_1 to BD3_n by detecting whether the voltages received by the input terminals IP1 to IPn fall within a detection voltage range. A calculation formula of the detection voltage range is as follows:

$$Detection voltage range = V S 2 * \frac{( R 80 / / R 1 )}{( RCS / / RCP ) + ( R 80 / / R 1 )} \pm ( V S 2 \times 2 \% )$$

In the above formula, VS2 is a voltage of the reference voltage VS2, which may be 2.5V in the embodiment. R80 is the resistance value of the resistor R80 in CNT21, which may be 80K ohms in the embodiment. R1 is the resistance value of the resistor R1 in the third circuit boards BD3_1, which may be 10K ohms in the embodiment. RCS is the resistance value of one of the resistors RCS1 to RCSn, and RCP is the resistance value of one of the corresponding resistors RCS1 to RCSn among the resistors RCP1 to RCPn. For example, when RCS is the resistance value of the resistor RCS1, then RCP is the resistance value of the resistor RCP1.

According to the above formula, Table 1 lists the detection voltage ranges of the controller CTR for the third circuit board BD3_1 to BD7 in the embodiment, and also lists the detection voltage ranges in the two cases of “third circuit board and cable are not inserted” and “only cable is connected, but third circuit board is not inserted”.

TABLE 1

| | Resistance value | Detection voltage | |
|---|---|---|---|
| Insertion status | of resistor RCS | range | |
| Third circuit board and cable are | The resistor RCS is | 2.5 ± 0.05 | V |
| not inserted | not connected | | |
| Third circuit board BD3_1 is | RCS1: 1K ohms | 2.25 ± 0.05 | V |
| inserted | | | |
| Third circuit board BD3_2 is | RCS2: 2K ohms | 2 ± 0.05 | V |
| inserted | | | |
| Third circuit board BD3_3 is | RCS3: 3.92K ohms | 1.75 ± 0.05 | V |
| inserted | | | |
| Third circuit board BD3_4 is | RCS4: 6.04K ohms | 1.5 ± 0.05 | V |
| inserted | | | |
| Third circuit board BD3_5 is | RCS5: 9.76K ohms | 1.25 ± 0.05 | V |
| inserted | | | |
| Third circuit board BD3_6 is | RCS6: 25.5 ohms | 0.75 ± 0.05 | V |
| inserted | | | |
| Third circuit board BD3_7 is | RCS7: 47.5K ohms | 0.5 ± 0.05 | V |
| inserted | | | |
| Only cable is connected, but third | Resistor RCS is | 1 ± 0.02 | V |
| circuit board is not inserted | not connected | | |

Taking the status of “third circuit board BD3_1 is inserted” in Table 1 as an example, when a detection object is the third circuit board BD3_1 and the resistance value of the resistor RCS1 is set to 1K ohms, the detection voltage range of the controller CTR for the third circuit board BD3_1 may be 2.25±0.05V. If the voltage value measured on the corresponding input terminal (assumed to be the input terminal IP1) falls within the interval of 2.25±0.05 V, the controller CTR may determine that the third circuit board BD3_1 is inserted into the correct position in the server device 200, and the controller CTR may control the first circuit board BD1 to transmit electric power to the correct position where the third circuit board BD3_1 is located. On the contrary, if the voltage value measured on the corresponding input terminal (assumed to be the input terminal IP1) exceeds the interval of 2.25±0.05V, the controller CTR may determine that the third circuit board BD3_1 is not inserted into the server device 200 or the insertion position of the third circuit board BD3_1 is incorrect.

Taking the status of “third circuit board BD3_2 is inserted” in Table 1 as an example, when the detection object is the third circuit board BD3_2 and the resistance value of the resistor RCS2 is set to 2K ohms, the detection voltage range of the controller CTR for the third circuit board BD3_2 may be 2±0.1V. If the voltage value measured on the corresponding input terminal (assumed to be the input terminal IP2) falls within the interval of 2±0.05 V, the controller CTR may determine that the third circuit board BD3_2 is inserted into the correct position in the server device 200, and the controller CTR may control the first circuit board BD1 to transmit electric power to the correct position where the third circuit board BD3_2 is located. On the contrary, if the voltage value measured on the corresponding input terminal exceeds the interval of 2±0.05V, the controller CTR may determine that the third circuit board BD3_2 is not inserted into the server device 200 or the insertion position of the third circuit board BD3_2 is incorrect.

Taking the status of “third circuit board and cable are not inserted” in Table 1 as an example, in this status, there should not be any third circuit board inserted into a specified position of the server device 200. Therefore, the detection voltage of the controller CTR for this status may be 2.5±0.05 V. If the voltage value measured on the corresponding input terminal (assumed to be the input terminal IP3) falls within the interval of 2.5±0.05 V, the controller CTR may determine that no third circuit board is inserted into the specified position in the server device 200.

Taking the status of “only cable is connected, but third circuit board is not inserted” in Table 1 as an example, in this status, there should not be any third circuit board inserted into a specified position of the server device 200, but the cable may be connected to the specified position of the server device 200. The detection voltage of the controller CTR for this status may be 1±0.02 V. If the voltage value measured on the corresponding input terminal (assumed to be the input terminal IP4) falls within the interval of 1±0.02 V, the controller CTR may determine that no third circuit board is inserted into the specified position in the server device 200, but the cable is connected to the specified position.

Note that the reference voltage VS1 and the reference voltage VS2 in the embodiment may be set according to actual requirement with no particular limitation.

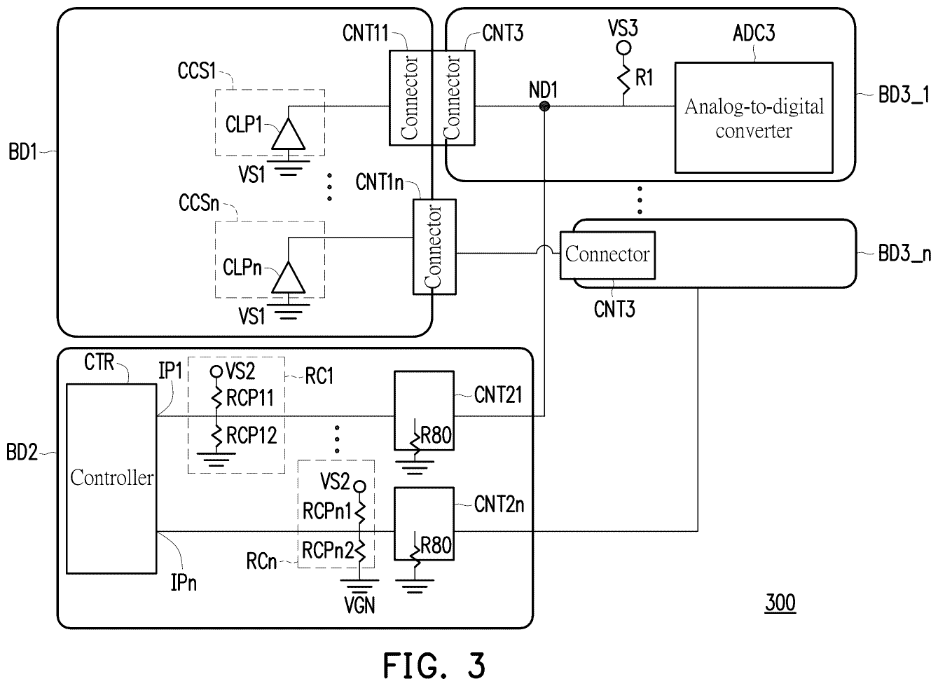

Please refer to FIG. 3. FIG. 3 illustrates a schematic circuit diagram of a server device according to an embodiment of the disclosure. The circuit components CCS1 to CCSn of a server device 300 may include clamp components CLP1 to CLPn respectively. The resistor circuits RC1 to RCn in the second circuit board BD2 include resistors RCP11 to RCPn1 respectively, and the resistor circuits RC1 to RCn in the second circuit board BD2 also include resistors RCP12 to RCPn2 respectively.

In the embodiment, the resistance value of the resistor R1 may be 1K ohms, the resistance values of the resistors RCP11 to RCPn1 may all be 1M ohms, and the resistance values of the resistors RCP12 to RCPn2 may all be 120K ohms. Note that the above resistance values may be set according to actual requirement with no particular limitation.

The clamp components CLP1 to CLPn may be disposed between the reference voltage VS1 and the connectors CNT11 to CNT1n respectively. The clamp components CLP1 to CLPn may all be Zener diodes, anode terminals of the Zener diodes all receive the reference voltage VS1, and cathode terminals of the Zener diodes are coupled to the corresponding connectors CNT11 to CNT1n respectively.

In the resistor circuits RC1 to RCn, the resistors RCP11 to RCPn1 may be disposed between the reference voltage VS2 and the corresponding input terminals IP1 to IPn respectively, and the resistors RCP12 to RCPn2 may be disposed between the corresponding input terminals IP1 to IPn and a reference voltage VGN respectively.

In the embodiment, the reference voltage VS1 and the reference voltage VGN may be the ground voltage (0V). The reference voltage VS2 and the reference voltage VS3 may be 3.3 volts (V). In addition, the controller CTR in the embodiment may be the analog-to-digital converter.

Note that of the clamp voltage values of the clamp components CLP1 to CLPn may be all different. Moreover, the clamp voltage values of the clamp components CLP1 to CLPn are all the breakdown voltages of the Zener diodes of the clamp components CLP1 to CLPn.

In the embodiment, the controller CTR may set the detection voltage ranges for the nodes ND1 to NDn (the nodes ND2 to NDn are not shown) of the third circuit boards BD3_1 to BD3_n respectively according to the clamp voltage values of the clamp components CLP1 to CLPn in the first circuit board BD1. Moreover, the controller CTR may individually determine the insertion statuses of the third circuit boards BD3_1 to BD3_n by detecting whether the voltages of the input terminals IP1 to IPn fall within the above detection voltage ranges. As follows, Table 2 lists the detection voltage ranges of the controller CTR for the third circuit board BD3_1 to BD7 in the embodiment, and also lists the detection voltage ranges in the two cases of “third circuit board and cable are not inserted” and “only cable is connected, but third circuit board is not inserted”.

TABLE 2

| | Clamp voltage value | Detection | |
|---|---|---|---|
| Insertion status | of clamp component | voltage range | |
| Tthird circuit board and | The clamp component | 0.5 ± 0.05 | V |
| cable are not inserted | is not connected | | |
| Insertion status BD3_1 | CLP1: 0.75V | 0.75 ± 0.05 | V |
| Insertion status BD3_2 | CLP2: 1V | 1 ± 0.05 | V |
| Insertion status BD3_3 | CLP3: 1.25V | 1.25 ± 0.05 | V |
| Insertion status BD3_4 | CLP4: 1.5V | 1.5 ± 0.05 | V |
| Insertion status BD3_5 | CLP5: 1.75V | 1.75 ± 0.05 | V |
| Insertion status BD3_6 | CLP6: 2V | 2 ± 0.05 | V |
| Insertion status BD3_7 | CLP7: 2.25V | 2.25 ± 0.05 | V |
| Only cable is connected, but | Clamp component | 0.25 ± 0.05 | V |

| | |
|---|---|
| third circuit board is not | is not connected |
| inserted | |

Taking the status of “third circuit board BD3_1 is inserted” in Table 2 as an example, when the detection object is the third circuit board BD3_1 and the clamp voltage value of the clamp component CLP1 is 0.75V, the detection voltage range of the controller CTR for the third circuit board BD31 may be 0.75±0.05V. If the voltage value measured on the corresponding input terminal (assumed to be the input terminal IP1) falls within the interval of 0.75±0.05V, the controller CTR may determine that the third circuit board BD3_1 is inserted into the correct position in the server device 300, and the controller CTR may control the first circuit board BD1 to transmit electric power to the correct position where the third circuit board BD3_1 is located. On the contrary, if the voltage value measured on the corresponding input terminal exceeds the interval of 0.75±0.05V, the controller CTR may determine the third circuit board BD3_1 is not inserted into the server device 300 or the insertion position of the third circuit board BD3_1 is incorrect.

Taking the status of “third circuit board BD3_2 is inserted” in Table 2 as an example, when the detection object is the third circuit board BD3_2 and the clamp voltage value of the clamp component CLP2 is 1V, the detection voltage range of the controller CTR for the third circuit board BD3_2 may be 1±0.05V. If the voltage value measured on the corresponding input terminal (assumed to be the input terminal IP2) falls within the interval of 1±0.05V, the controller CTR may determine that the third circuit board BD3_2 is inserted into the correct position in the server device 300, and the controller CTR may control the first circuit board BD1 to transmit electric power to the correct position where the third circuit board BD3_2 is located. On the contrary, if the voltage value measured on the corresponding input terminal exceeds the interval of 1±0.05V, the controller CTR may determine that the third circuit board BD3_2 is not inserted into the server device 300 or the insertion position of the third circuit board BD3_2 is incorrect.

Taking the status of “third circuit board and cable are not inserted” in Table 2 as an example, in this status, there should not be any third circuit board inserted into a specified position of the server device 300. Therefore, the detection voltage of the controller CTR for this status may be 0.5±0.05 V. If the voltage value measured on the corresponding input terminal (assumed to be the input terminal IP3) falls within the interval of 0.5±0.05 V, the controller CTR may determine that no third circuit board is inserted into the specified position in the server device 300.

Taking the status of “only cable is connected, but third circuit board is not inserted” in Table 2 as an example, in this status, there should not be any third circuit board inserted into the specified position of the server device 200, but the cable may be connected to the specified position of the server device 300. The detection voltage of the controller CTR for this status may be 0.25±0.05 V. If the voltage value measured on the corresponding input terminal (assumed to be the input terminal IP4) falls within the interval of 0.25±0.05 V, the controller CTR may determine that no third circuit board is inserted into the specified position in the server device 300, but the cable is connected to the specified position.

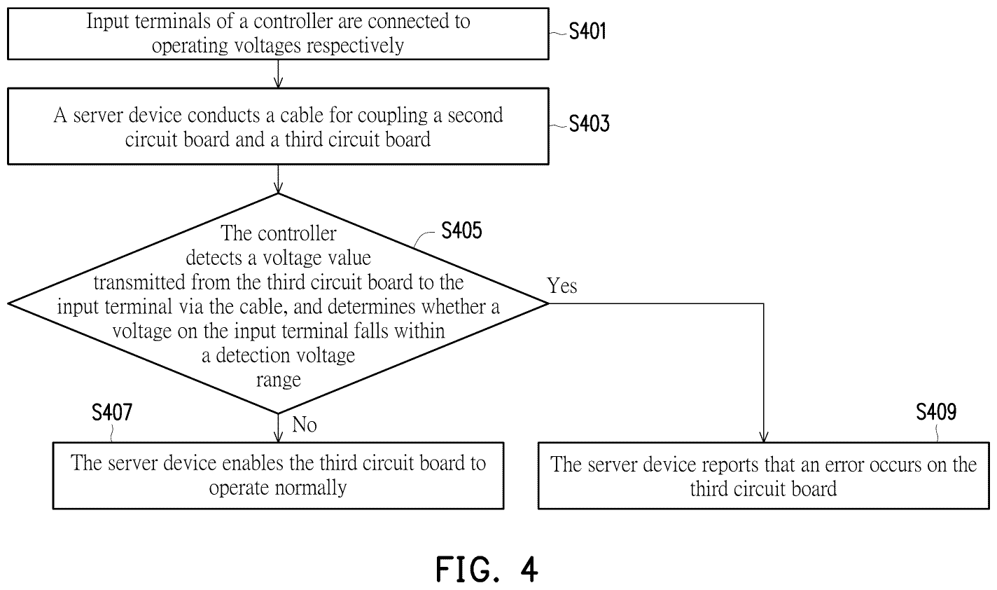

Please refer to FIG. 4. FIG. 4 illustrates an operational flow chart of a server device according to an embodiment of the disclosure. The server device in the embodiment includes a first circuit board, a second circuit board, and n third circuit boards. The second circuit board has a controller, and the controller has n input terminals. The n input terminals of the controller may correspond to the n third circuit boards respectively. The value n mentioned in the embodiment may be any positive integer.

In Step S401, the input terminals of the controller are connected to operating voltages respectively. In Step S403, the server device conducts a cable for coupling the second circuit board and the third circuit board. In Step S405, the controller detects a voltage value transmitted from the third circuit board to the input terminal via the cable, and determines whether a voltage on the input terminal falls within a detection voltage range. If yes, the server device executes Step S407; and if not, the server device executes Step S409.

In Step S407, the server device enables the third circuit board to operate normally. In Step S409, the server device reports that an error occurs on the third circuit board.

Regarding the implementation details of the above steps, the detailed descriptions have been made in the foregoing embodiments and will not be described in detail here.

In summary, the server device of the disclosure may use the first circuit board to set multiple groups of detection voltage ranges, and use these detection voltage ranges as the standard to correspondingly detect the voltages on the input terminals of the controller to simultaneously determine whether each detachable third circuit board is disposed at the correct position between the first circuit board and the second circuit board, thereby reducing signal lines and reducing circuit area.

What is claimed is:

1. A power management method, suitable for a power supply device, comprising:
in a backup mode, enabling a first power supply that is a master power supply to receive a power setting value, and limiting a first output power value of the master power supply to be not larger than the power setting value; and
in the backup mode, enabling a second power supply that is a slave power supply to be activated, and controlling an output power of the slave power supply to be a second output power value, wherein the second output power value is set according to a difference between a total load of the power supply device and the first output power value.

2. The power management method according to claim 1, further comprising:
when the power setting value is larger than the total load, enabling the slave power supply to be deactivated.

3. The power management method according to claim 1, further comprising:
adjusting the first output power value of the master power supply by adjusting an output voltage of the master power supply.

4. The power management method according to claim 1, further comprising:
when the master power supply is faulty, enabling the second output power value of the slave power supply to increase to be equal to the total load of the power supply device.

5. The power management method according to claim 1, further comprising:
in a normal mode, enabling the first output power value of the master power supply and the second output power value of the slave power supply to be both half of the total load of the power supply device.

6. The power management method according to claim 1, further comprising:
switching the first power supply to be the slave power supply, and switching the second power supply to be the master power supply.

7. A server system, comprising:
a load device; and
a power supply device, coupled to the load device, comprising:
a first power supply, configured as a master power supply; and
a second power supply, configured as a slave power supply and coupled in parallel with the first power supply,
wherein in a backup mode, the load device provides a power setting value to the master power supply, a first output power value provided by the master power supply is not larger than the power setting value, and the load device sets a second output power value provided by the slave power supply according to a difference between a total load of the power supply device and the first output power value.

8. The server system according to claim 7, wherein when the power setting value is larger than the total load, the slave power supply is deactivated.

9. The server system according to claim 7, wherein the master power supply adjusts a generated internal output voltage to adjust the first output power value provided by the master power supply.

10. The server system according to claim 7, wherein when the master power supply is faulty, the master power supply sends a fault signal to the load device, the load device enables the second output power value of the slave power supply to increase to be equal to the total load of the power supply device according to the fault signal.

11. The server system according to claim 7, wherein in a normal mode, the first output power value of the master power supply and the second output power value of the slave power supply are both half of the total load of the power supply device.

12. The server system according to claim 7, wherein the load device sends a command to switch the first power supply to be the slave power supply, and switch the second power supply to be the master power supply.

13. The server system according to claim 7, wherein each of the first power supply and the second power supply comprises:
a controller, generating a power setting signal according to the power setting value, an internal current signal of the first power supply or the second power supply, an external current signal of the power supply device, and an external voltage signal;
a power generator, receiving an input voltage and generating an internal output voltage according to a pulse width modulation signal; and
a pulse width modulation signal generator, coupled to the power generator and the controller to adjust the pulse width modulation signal according to the power setting signal.

14. The server system according to claim 13, wherein each of the first power supply and the second power supply further comprises a current detector for detecting the internal current signal of the first power supply or the second power supply.

15. The server system according to claim 13, wherein the controller comprises:
a digital signal processing circuit, generating control information according to the power setting value, the internal current signal, the external current signal, and the external voltage signal; and
a power setting circuit, coupled to the digital signal processing circuit to generate the power setting signal according to the control information.

16. The server system according to claim 13, wherein the pulse width modulation signal generator comprises:
a feedback circuit, receiving the external voltage signal to generate a feedback signal; and
a periodic signal generating circuit, coupled to the power generator, the controller, and the feedback circuit to generate the pulse width modulation signal according to the feedback signal and the power setting signal.

17. The server system according to claim 7, wherein the load device comprises:
a substrate management controller, configured to provide the power setting value and the second output power value.

18. A power supply device, comprising:
a first power supply, configured as a master power supply; and
a second power supply, configured as a slave power supply and coupled in parallel with the first power supply,
wherein in a backup mode, the master power supply receives a power setting value, a first output power value of the master power supply is limited to be not larger than the power setting value, and an output power of the slave power supply is a second output power value, wherein the second output power value is set according to a difference between a total load of the power supply device and the first output power value.

19. The power supply device according to claim 18, wherein each of the first power supply and the second power supply comprises:
a controller, generating a power setting signal according to the power setting value, an internal current signal of the first power supply or the second power supply, an external current signal of the power supply device, and an external voltage signal;
a power generator, receiving an input voltage and generating an internal output voltage according to a pulse width modulation signal; and
a pulse width modulation signal generator, coupled to the power generator and the controller to adjust the pulse width modulation signal according to the power setting signal.

20. The power supply device according to claim 18, wherein each of the first power supply and the second power supply further comprises a current detector for detecting the internal current signal of the first power supply or the second power supply.

21. The power supply device according to claim 18, wherein the controller comprises:
a digital signal processing circuit, generating control information according to the power setting value, the internal current signal, the external current signal, and the external voltage signal; and
a power setting circuit, coupled to the digital signal processing circuit to generate the power setting signal according to the control information.

22. The power supply device according to claim 18, wherein the pulse width modulation signal generator comprises:
a feedback circuit, receiving the external voltage signal to generate a feedback signal; and
a periodic signal generating circuit, coupled to the power generator, the controller, and the feedback circuit to generate the pulse width modulation signal according to the feedback signal and the power setting signal.

23. The power supply device according to claim 22, wherein the feedback circuit comprises:
a current amplifier, receiving the internal current signal and generating an amplified internal current signal; and
a comparator, comparing the amplified internal current signal with the power setting value to generate the feedback signal.

24. The power supply device according to claim 18, wherein when the power setting value is larger than the total load, the slave power supply is deactivated,
wherein when the master power supply is faulty, the slave power supply increases the generated second output power value to be equal to the total load of the power supply device,
wherein in a normal mode, the first output power value of the master power supply and the second output power value of the slave power supply are both half of the total load of the power supply device.
